(19) United States
(12) Patent Application Publication
(10) Pub. No.: US 2010/0268673 A1
(43) Pub. Date: Oct. 21, 2010

(54) ASSOCIATE MEMORY LEARNING AGENT TECHNOLOGY FOR TRAVEL OPTIMIZATION AND MONITORING

(75) Inventor: Leonard J. Quadracci, Seattle, WA (US)

Correspondence Address: HARNESS DICKEY & PIERCE, PLC, P.O. BOX 828, BLOOMFIELD HILLS, MI, 48303, US

(73) Assignee: The Boeing Company, Chicago, IL (US)

(21) Appl. No.: 12/424,638

(22) Filed: Apr. 16, 2009

(51) Int. Cl. G06F 15/18; G06F 17/30

(52) U.S. Cl. 706/12; 707/E17.014; 707/E17.015

(57) ABSTRACT

A method for assisting with evaluating travel related information. The method may involve defining a plurality of entity types for categorizing different types of travel related information. A data mining tool may be used to search at least one database for stored travel related information, and to denote specific items of the travel related information as entities. The data mining tool may be used to populate an associative learning memory with the entities and to store the entities in the associative learning memory. An entity analytics engine may be used to assist a user in searching the associative learning memory for specific ones of the entities that are at least one of identical or similar to specific travel related information provided by the user. Retrieved ones of the entities may be displayed for evaluation by the user.

### FIELD

The present disclosure relates to systems and methods for analyzing travel expenditures, and more particularly to systems and methods adapted to collect and analyze large amounts of travel expenditure data to assist a user in analyzing travel expenditure transaction patterns where cost savings or improved travel quality may be obtained.

### BACKGROUND

The statements in this section merely provide background information related to the present disclosure and may not constitute prior art.

A present day challenge is the ability to rapidly and accurately identify travel use patterns to optimize savings, as well as to identify travel “over” and “under” expenditures for both pre-travel and post-travel analysis. Such analysis may prove useful when comparing travel expenditures of one individual, or possibly a group of individuals from one department or division of an organization, with travel expenditures of a different individual or different group of individuals from a different department or division of the organization, for similar or identical travel itineraries.

Complicating the analysis of travel related data is that the options associated with travel are typically highly varied. For example, variations may exist with originating locations, final destination locations, intermediate stops or locations on a given trip, the duration of stay, the purpose of the travel, the type of person traveling (management, sales, executive, engineer, etc.), the mode of travel, the number of travelers in a group, etc. it is typically difficult, if not impossible, to find the “best” or “most similar travelers” when trying to compare expenditures of a previous trip to those likely to be incurred on a current trip.

Modern database systems and processes are well known and can handle extensive amounts of data. But while such systems may be able to provide some limited amounts of cost information for a given, anticipated trip, such existing systems typically do not take into account the many variable that drive the actual costs of an upcoming trip.

With some travel analysis systems there is a focus on creating and using “authorized”, “favored” or “negotiated” rates for car rentals, hotel rooms, etc. However, one drawback with such systems is that better rates may not be identifiable, or if found, may not used by additional travelers because the travelers may simply not be aware of the available preferred rates.

Still further, some travel cost analysis systems that attempt to construct an “average” or “normal” cost range for travel to a given city. But such systems often do not take into account many important variables that may significantly influence the cost of such a trip, such as the number of days in advance that the trip is scheduled, the time of year that the trip is taken, flight departure times, whether non-stop flights are involved, etc.

Existing travel cost analysis systems are also typically “reductive”, meaning that from the total information input by a user into the system, only a portion of the total input information may be used by the system to actually perform searching activities for important travel related cost information. This may lead to specific information being missed or “overlooked” by the system that would otherwise be helpful in analyzing specific travel expenditure information. A further consequence is that much of the association data between pieces of information may be lost, because the system is “forced” into characterizing a travel record, an organization, a travel transaction (e.g., hotel stay, car rental, etc.), a person (e.g., manager, engineer, etc.), by pre-defined characteristics and/or limited pre-selected words. For example, a “cost range” input provision of a typical existing system may provide no means for making a distinction between the costs incurred by an entry level employee on a given trip, versus the costs incurred by a senior executive of a large organization visiting the same city at the same time of year. This may result in the system not recognizing important distinctions between different travelers from a given organization, as well as important cost expectations that are reasonable and expected for different individuals of a given organization.

Some existing travel analysis solutions use rules to group together or break apart and put travel expenditures into different categories so that they can be compared. The problem is that by segregating expenditures into arbitrary groups, it makes it difficult or impossible for the system to “learn” and improve its ability to recognize and more accurately classify specific types of information or expenses as being related, or properly belonging to one or more different predefined categories.

In view of the foregoing, it will be appreciated that a key to improving travel is the ability of an organization to learn “better” ways to travel. An important element of “learning” may involve finding other travel options that are better before traveling, but it is also useful to know (i.e., learn) after the travel has been completed that a better travel itinerary was possible. Thus, one factor in improving travel efficiency and quality within organization, especially within large organizations with thousands of employees, may be finding and analyzing relevant travel experience(s) of other travelers and using those experiences to learn from that experience.

### SUMMARY

In one aspect the present disclosure relates to a method for assisting with evaluating travel related information. The method may comprise defining a plurality of entity types for categorizing different types of travel related information. A data mining tool may be used to search at least one database for stored travel related information, and to denote specific items of the travel related information as entities. The data mining tool may be used to populate an associative learning memory with the entities and storing the entities in the associative learning memory. An entity analytics engine may be used to assist a user in searching the associative learning memory for specific ones of the entities that are at least one of identical or similar to specific travel related information provided by the user. Retrieved ones of the entities may be displayed for evaluation by the user.

In another aspect the present disclosure relates to a method for managing and analyzing travel information. The method may comprise using an associative learning memory to store a plurality of entities, each one of the entities relating to a specific piece of the travel related information. An input device may be used that allows a user to input a travel plan or travel expense report (TER) relating to specific travel related information. An entity analytics engine responsive to the input device may be used to search the associative learning memory for specific ones of the entities that are related to the travel plan or the TER input by the user. The entities retrieved by the entity analytics engine may be displayed on a display for consideration by the user.

In still another aspect the present disclosure relates to a system for assisting with evaluating travel related information. The system may comprise a data mining tool to search at least one database for stored travel related information, and to denote specific items of the travel related information as entities. An associative learning memory may be used to communicate with the data mining tool, and may be adapted to store the entities created by the data mining tool. An entity analytics engine is responsive to travel entities provided by a user, where the entities each have a plurality of entity attributes. The entity analytics engine may also be adapted to search the associative learning memory for specific ones of the travel entities that are at least one of the entity attributes, and to collect the identical or similar entities stored in the associative learning memory to generate a report that assists the user in one of planning a trip or evaluating a completed trip.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level block diagram of one exemplary embodiment of a system in accordance with the present disclosure;

FIG. 2 is a diagram illustrating how entity types and specific entities may be organized in an associative learning memory of the system;

FIG. 3 is a flowchart illustrating operations that may be performed by the system in creating an optimized travel itinerary for a user based on the information input by the user that pertain to various aspects of the user's upcoming trip;

FIG. 4 is a flowchart illustrating operations that may be performed in creating or updating a travel expense report and letting the user know if the travel expense report (“TER”) is out of the range for similar travel and request a justification; and

FIG. 5 is a flowchart illustrating operations that may be performed while using the system to enable a second individual to evaluate and grade a travel expense report (TER) previously submitted by a first individual.

### DETAILED DESCRIPTION

The following description is merely exemplary in nature and is not intended to limit the present disclosure, application, or uses. It should be understood that throughout the drawings, corresponding reference numerals indicate like or corresponding parts and features.

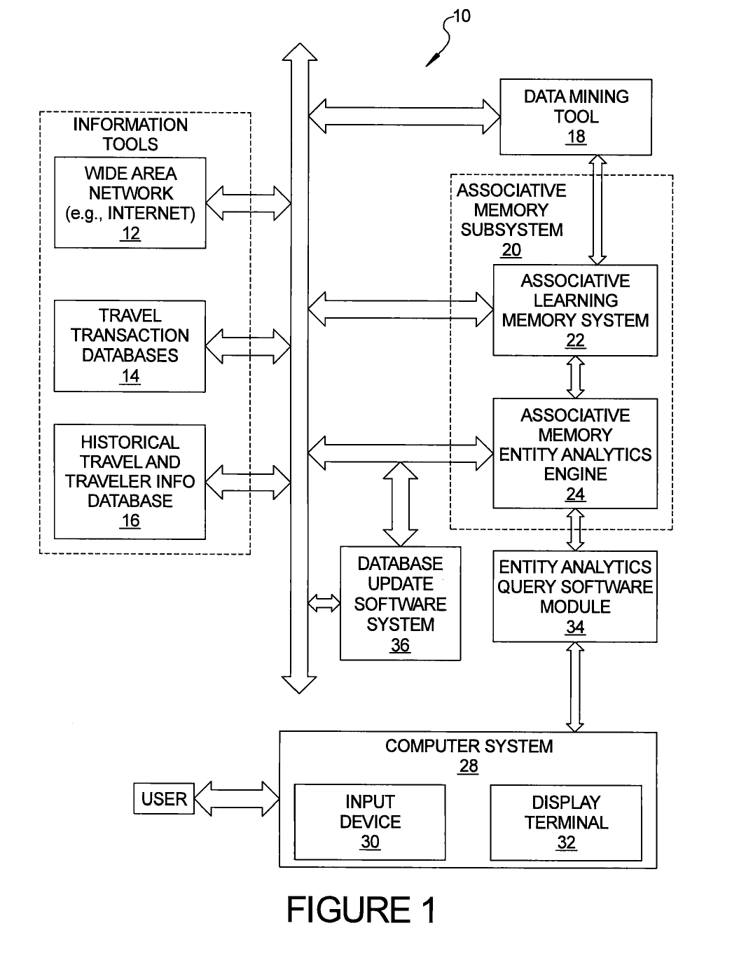

Referring to FIG. 1, there is shown one embodiment of a system 10 in accordance with the present disclosure for analyzing travel expense related information and assisting with optimizing travel planning. The system 10 is particularly useful in helping a user plan a travel itinerary to so the itinerary is optimized both from a qualitative standpoint and also a quantitative cost standpoint. The system 10 is also highly useful for analyzing travel expense reports (hereinafter “TERs”) and comparing a given TER with other previously incurred travel expenses and previously generated TERs by other individuals. The comparison that the system 10 is able to perform enables the travel details of a given trip by an individual, or group of individuals, to be compared against other identical or similar trips taken previously by other individuals, so that the qualitative and quantitative results of the given trip can be realized, as well as recorded for future use by other individuals. While the system 10 is especially well suited for use with large organizations having hundreds, thousands or more employees, the system 10 may be used to improve travel planning and travel effectiveness, both from cost and qualitative standpoints, for small and medium sized organizations as well. The system 10 is expected to find utility in essentially in any application where travel planning or the analysis of travel performed, both from a qualitative standpoint as well as a quantitative cost standpoint, is desired or necessary. Accordingly, the system 10 is expected to find utility with private corporations or government agencies of all sizes that have individuals that are required to travel on company business, and possibly even travel planning organizations that assist private or public entities with travel planning.

Referring to FIG. 1, the system 10 may include one or more independent information storage tools where various forms of travel related information may be stored. Three such exemplary information storage tools are illustrated as a wide area network 12 (for simplicity “web 12”), one or more travel transaction databases 14 and one or more historical databases 16. However, it will be appreciated that any type of database or information storage system capable of storing travel related information may be used with the system 10. Travel transaction databases 14 may comprise one or more independent databases that are used to store relatively current travel transaction information, for example travel transaction information that has occurred within the prior 48 month period. Such information may, for example and without limitation, be in the form of TERs submitted by individuals and TER grading reports submitted by a management person responsible for overseeing the efficient use of travel fund resources. The transactional databases 14 may also include, without limitation, specific travel related records such as expense information for specific hotels/motels; specific car rental transaction records; airline ticket transaction records; dry cleaning transaction cost records; specific restaurant transaction records; cab fare records; costs associated with entertainment during a trip; parking costs at specific parking lots or structure; the origination and destination locations, as well as intermediate stop locations, for a given trip; as well as complete records of trip costs for specific individuals or collective records for individuals belonging to a specific department or division of an organization. Information concerning the job description of the individual, whether an entry level person, engineer, maintenance worker, executive level person, CEO, etc., may also be stored in the travel transaction databases along with the TERs submitted by such individuals. Still further, the reason for the trip may be stored with each TER submitted, along with specific notes created by each individual summarizing their experiences with specific hotels, restaurants, parking lots, etc., which may prove valuable to other individuals when planning future trips.

Historical database 16 may be used to store quantitative or qualitative travel related, historical transaction information such as any of the information described above that is stored in the travel transaction database. The historical database 16 may also be used to store historical TER reports generated by management, so that travel costs to certain destinations can be analyzed over a time period, for example over a several year long period. Virtually any other type of historical travel related information may be stored in the historical database 16. The system 10 is especially valuable for enabling a user to quickly search and identify travel itineraries that may have some relation to one another, such as a common destination or origin. Such a relation may be repeated transactions using a particular credit card company. Or the relation may be the same type of purchase, for example repeated stays at a given hotel in a given city. However, without the use of the system 10, simply identifying identical or similar travel related transactions from a large database of diverse transactions could prove to be too costly and time consuming to be performed by individuals through routine database searching. Complicating this is that with many previously developed database systems, the travel related transaction information will typically be entered by numerous individuals. As such, there often exist differences in terminology, spelling and vernacular that can further limit the effectiveness of conventional database searching in identifying related travel transaction information. Previously developed database systems also often are limited to the use of drop down menus for selecting categories of information to be searched. Thus, they can be susceptible to missing similar types of travel information or transactions that may not be describable within the limitations of the drop down menu options that the system provides.

With further reference to FIG. 1 the system 10 also may include a data mining tool 18 and an associative memory subsystem 20. The data mining tool 18 may be in bidirectional communication with the information tools 12, 14, and 16, and also with the associative memory subsystem 20. The associative memory subsystem 20 may include an associative learning memory 22 (hereafter simply “associative memory 22”) and an associative memory entity analytics engine 24 (hereinafter the “entity analytics engine 24”). A computer system 26 having a processor 28, an input device 30 and a display device 32 may communicate bidirectionally with the entity analytics engine 24. The input device 30 may be a keyboard or any other component suitable for allowing the user to input search terms such as words, numbers or possibly even symbols. The associative memory 22 is also in bidirectional communication with the entity analytics engine 24. The entity analytics engine 24 may make use of one processor, but more typically a plurality of processors, that operate in connection with entity analytics query software 34 to perform queries for information stored in the associative memory 22. The entity analytics engine 24 receives travel related information queries from a user via the input device 30 and the query software 34 and controls the generation of entities for a given input query by the user. By “entities” it is meant specific information relating to either specific types of reports, such as TERs, or specific travel related transactions such as a hotel bill for a specific hotel stay, a parking bill for parking at a specific parking facility, etc. Thus, an entity may be either a collection of travel information (e.g., TER) or specific itemized travel transactions with specific vendors. The types of entities may be defined by a system designer during construction of the system 10. This will be explained in greater detail in the following paragraphs.

A principal advantage of the system 10 is that it is able to receive and analyze individual words, numbers or even symbols from a “report” input by a user, and to use all of the “attributes” of the input information in performing searching of the associative memory 22 for pertinent travel related information. By the terminology “attribute” it is meant any piece of knowledge or characteristic such represented by adjectives, verbs, nouns (e.g., “travelled”, “hotel”, “flight”, “overbooked”, “discount”; “meal”, “inconvenient”, “parking”, “paid”; “refund”, “St. Louis”, “December”, “evening”, XYZ Restaurant”, “John Doe”, “executive”, “training seminar”, etc.) that may be helpful in searching the associative memory 22 for travel documents or experiences that are similar to the given input document.

A database update software system 36 may be used to update the information tools 12, 14 and 16 with any documents created by the user or by management personnel, such as TERs or qualitative or quantitative reports concerning the evaluation of TERs. The entity analytics engine 24 periodically updates the associative memory 22 with new information retrieved from information tools 12, 14 and 16 so that the associative memory 22 will contain all of the entity information available to the system 10 when the system is next accessed for use by a user.

As touched on above, prior to a first use of the system 10 a system designer defines at least one entity type, but more typically a plurality of entity types that relate to specific categories of information that may be used to help identify or evaluate a specific type of financial transaction. For example, one entity type may be “Food Providers”, and various entities such as “XYZ Restaurant”, “DEF Sub Sandwiches”, “GED Pizzeria”, may all be specific entities that are created by the system 10 and stored in the associative memory 22. Another entity type may be “Destinations”, and specific entities may be specific cities that have been visited by employees of an organization. Another entity type may be “Employee Type”, and specific entities may be “engineer”, “accountant”, “mechanic”, “sales executive”, etc. Still another entity type may be “Airports”, which specific airports around the world listed as entities. Virtually any category of information that may be relevant to describing a type of travel related information or travel expense may be defined by a system designer as an entity type.

The entity types and entities are initially mapped and stored into the associative memory 22 by the data mining tool 18. The data mining tool 18 identifies a plurality of entities as it reviews all of the information available in the information tools 12, 14 and 16 and sends the identified information to the associative memory 22 for storage as independent entities. Thus, each specific entity type may have associated with it at least one, but more typically a plurality of different specific entities. Depending on the size of the organization implementing the system 10, dozens or more entity types may be defined by the system designer to identify categories of information that may be useful in helping the user or management to analyze travel related information and/or travel itineraries or travel related costs associated with specific vendors, or travel costs during certain time periods. An example of an entity analytics engine available commercially is “SAFFRON ENTERPRISE™” available from Saffron Technology of Morrisville, N.C. It will be appreciated that the entity analytics query software 34 will be constructed by the system designer to recognize those words, numbers or even characters or symbols that are expected to be important to analyzing and working with travel related information.

The computer input device 32, which may be a keyboard or any other suitable input component, may be used by individuals to input complete TERs to the system 10, to input only specific items of travel related information (e.g., flight costs, meal costs, etc.), to search for similar trip itineraries to the trip being planned by the individual. The input device 32 may be used by management persons to retrieve and analyze TERs of specific individuals, TERs submitted by individuals from specific departments or divisions, or to input TER evaluation reports. All or portions of the foregoing information may be stored by the associative memory 22 as entities for future use. The ability of the system 10 to use all the free text terms in the entity analysis search provides a significant advantage because it enables the system 10 to obtain all relevant entities that may be relevant to the requested analysis.

Another significant advantage of the system 10 is that it does not make use of reductive algorithms, which can actually eliminate some portions of input information that describe or characterize the transaction that could be helpful in identifying particular vendors, entities or types of transactions. Such reductive algorithms may typically categorize transactions or events into specific categories. This may result in relevant transaction information being overlooked or missed by conventional database systems because the system may not recognize or allow for the input of important words or phrases that may be relevant to the analysis. It might be a key phrase that identifies the part of the travel that is of most use. For example the planning document might describe the travel as support of a “Shuttle Launch” and that might be a better match than the generic description “travel to Houston”. The system 10 provides the significant advantage that it allows the user to use all words, numbers, symbols, etc. that are associated to the entity types that the user feels may be relevant to the transaction investigation.

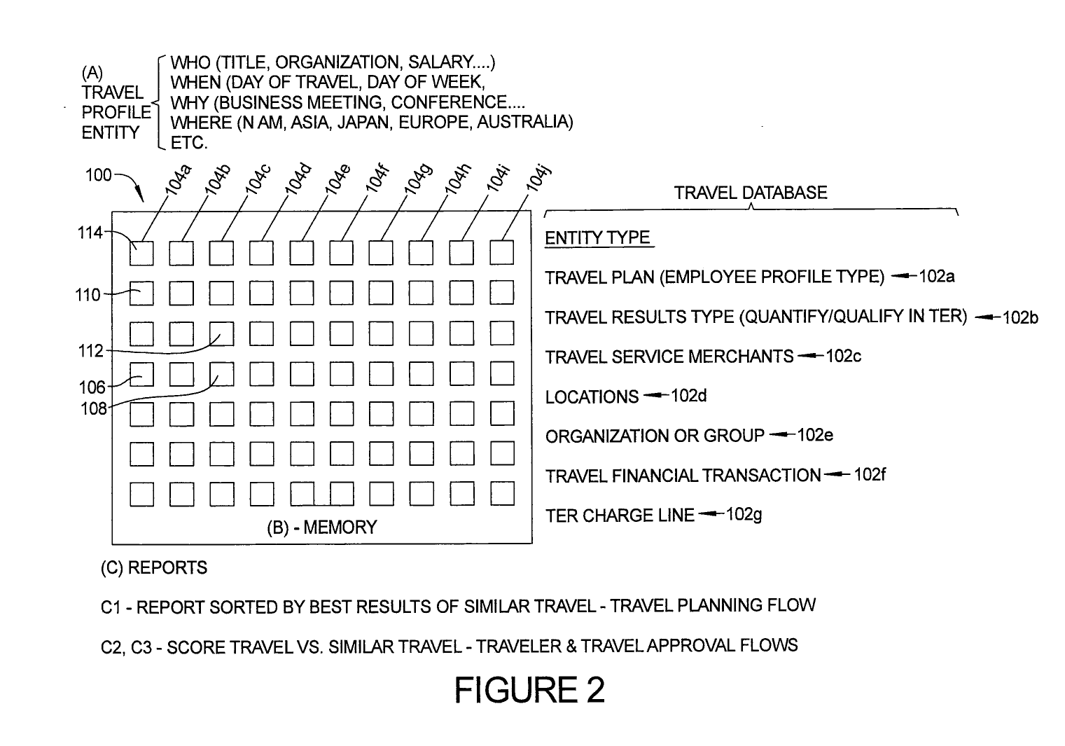

Referring to FIG. 2, a diagram 100 is shown that illustrates how various entity types and entities may be organized in the associative memory 22. Rows 102a-102g illustrate categories of information that are used by the system designer to denote entity types. Columns 104a-104j represent specific entities of each entity type. For example, box 106 denotes St. Louis, Mo. as an entity, while box 108 denotes Seal Beach, Calif. as a different entity. Box 110 denotes may denote a specific airline as an entity, while box 112 may denote a specific hotel in a specific city. Box 114 may denote a specific travel plan created by a specific employee, while box 116 may relate to one specific TER submitted by an individual. Organization or group entity type may remember all the information associated with the travel for a specific organization or group. This may be used to find groups inside of a company that travel to the same set of locations or have the same kind of purposes for travel. Travel Financial Transaction entity type would be any purchase using any method for travel. This entity type would be populated by credit card transactions, cash transactions or purchase orders. By creating one entity type that is populated by several sources is that it is possible to find similar transactions even if they use different methods of payment.

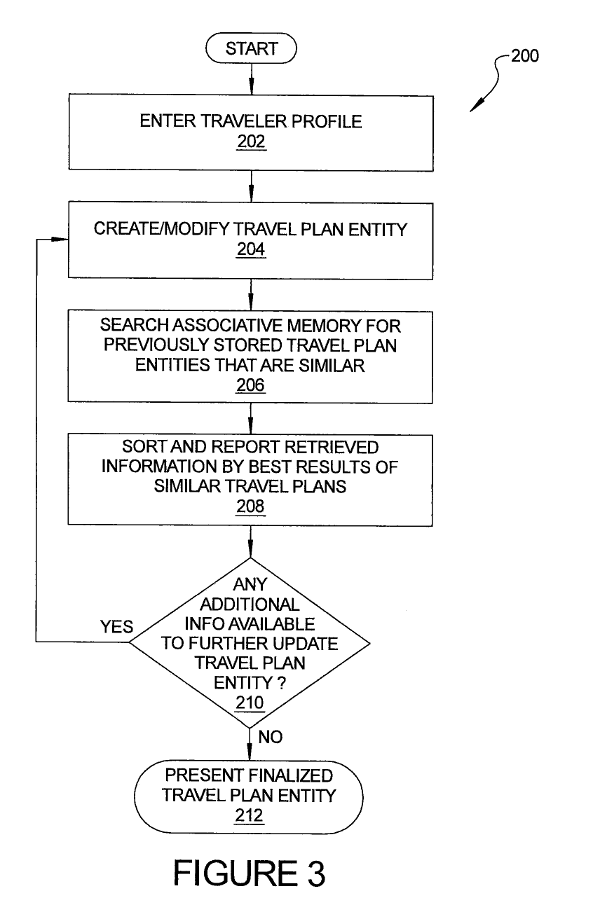

Referring to FIG. 3, a flowchart 200 is shown that sets forth exemplary operations that may be performed by the system 10 in creating an optimized travel itinerary for an individual for a given trip the individual needs to take. At operation 202 the individual enters a “traveler profile” via the input device 30, which may include basic information concerning the individual such as the classification of the individual (sales person, engineer, entry level employee, executive, etc.), any special physical needs or disabilities of the individual, etc. At operation 204 the individual creates or modifies a preexisting travel plan (i.e., travel itinerary) by inputting various information pertaining to the trip that needs to be planned. Such information may be input via the user device 30 to the system 10 after which the entity analytics software module 34 will control the entity analytics engine 24 in searching the associative memory 22 for all identical or similar entities that pertain to the travel plan entity input by the individual. Such information in the travel plan may be a combination of structured data and free text form to describe various trip details such as the airport that the individual will be departing from, the airport at the destination location, the city being visited, the dates that travel will be occurring between, whether a rental car will be needed, the dates of the trip, whether morning or evening travel is preferred or required during any leg of the trip, etc. Essentially any information that may be needed by or useful to the individual in creating a travel plan may be input by the individual.

At operation 204 the entity analytics engine 24 searches the associative memory 22 for any stored entities (i.e., travel plans) that have similar characteristics, such as the same destination, same origin, etc. At operation 204 the entity analytics engine 24 sorts the retrieved information by the best results of similar travel plans. By this it is meant that the entity analytics engine 24 looks for those travel plans that have the same destination, or a destination most near to the user's destination, and all other trip details that may be helpful to find truly similar trips. Such other details may be purpose of the trip, charge line for the trip (e.g. Business Development, Maintenance or Finance), time of year (e.g. normal, or near holiday season, etc.). At operation 206 the system starts with a list of similar travel planning entities and now the system looks at the “results” of those similar travel plans. It will sort the results and report the best set of results to the user. The definition of best can include lowest cost, best quality or value, or a combination of those criteria. The user may then take the best features of the actual travel and repeat or improve on those features. For example if two similar trips had the same hotel cost then the user may choose the one that had a better previous traveler quality result. One trip may look less expensive because the traveler took the subway and not a cab but the traveler might report that they had safety concerns because of the walk from the substation to the meeting location.

At operation 208 the entity analytics engine 24 checks to determine if any further relevant travel information is available that may be used to update/modify the travel plan entity being formed for the user. If so, then operations 202-208 are repeated. If not, then a finalized, suggested travel plan entity is presented to the user at operation 210. This plan may have recommendations for one or more hotels, restaurants, and other helpful information. Information such as discounts available to the organization that the user is with may also be presented to the user to help him/her finalize decisions concerning the upcoming trip. Comments from previous travelers concerning experiences with specific hotels, restaurants, paid parking lots, freeway or traffic congestion at times of day, etc., from the associated travel results entity may also be presented. Advantageously, the information used to form the finalized travel plan entity is obtained rapidly, typically within 10-seconds, from potentially tens of thousands or more of stored entities representing previously planned and taken trips by others in the organization. The collection of information in the travel plan entity generated at operation 208 also allows the user to plan an optimized trip, both from a quantitative (i.e., cost) standpoint as well as a qualitative standpoint.

The use of the associative memory 22 and the entity analytics engine 24 forms an effective tool optimizing and monitoring on-going travel operations at an organization. The system 10 is capable of determining the comparative costs of trips both before and after travel occurs. A particular advantage of the associative memory 22 and the entity analytics engine 24 is being able to group like data into similar groups of data, even though the data may have been entered in different descriptors or different syntax. Thus the data entered by the user does not have to match exactly the wording or previous entries made by other individuals, and the system 10 is still able to detect the correlation between similar types of stored information.

The system 10 is also effective at identifying specific vendors or businesses that the user's organization is doing a large volume of business with. This enables the user's organization to potentially negotiate discounts with specific vendors or other agreements that may be beneficial to the organization, or to both the organization and specific vendors. For example, consider a situation where parking at a specific parking structure in a specific city, for example JJJ Gateway Parking, and specific transaction with this vendor are expensive and have been input into the system 10 in the past by individuals using slightly different titles (e.g., “JJJ Parking” or “Parking at JJJ”). Without the free text association that is provided by the system 10, the similar, but not identical named entries, could be difficult or impossible for a conventional database searching system to identify. In a large organization, the task of going through tens of thousands of expense reports to find the all those relating to JJJ Parking and Parking at JJJ could take hours or days, to accomplish by a conventional database system, or possible days or weeks for an individual searching manual travel records. However, the associative memory 22 and the entity analytics engine 24 enable rapid retrieval of all similar types of data to be performed from tens of thousands or more travel related records, and typically within only seconds.

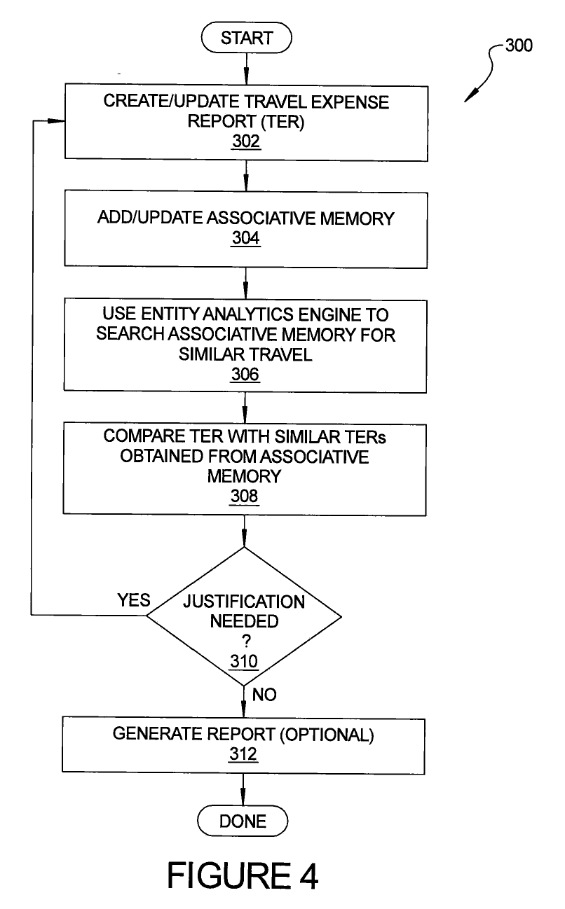

Referring now to FIG. 4, a flowchart 300 is shown of various operations that may be performed in updating the associative memory 22 after a trip by a user. At operation 302 the user may create or update a previously started travel expense report (TER) or a travel plan using the input device 30 of the computer system 28. This may involve inputting information typically submitted in a conventional expense report or travel plan such as the purpose of a trip, hotel(s) stayed at, airline(s) used, restaurant's visited, and the costs associated with each, or it may simply involve entering an entity number assigned to by the system 10 to a previously generated TER or a previously generated travel plan. The user may also input specific comments concerning her/his experiences at certain businesses. For example, the user may input comments on the quality of a stay at a given hotel, or other specifics such helpful specific remarks such what time to checkout by in the morning to avoid a rush, which hotels or restaurants are most easily accessible from freeways or convenient (or inconvenient) for other reasons. Still other remarks by the user may relate to travel alternatives, such as a remark “Take the train—it is faster and cheaper than renting a car”, or “The B&B is actually cheaper because breakfast is included. Ask for back room to avoid road noise.” Thus, useful comments that are likely to assist future travelers in optimizing a trip may be stored by the system 10 as a TER entity (Travel Expense Report) that is associated with a Travel Plan Entity created before the trip at operation 304 along with basic or fundamental trip expenses.

At operation 306 the entity analytics engine 24 searches the associative memory 22 for previously recorded TER entities representing previously taken trips by other individuals in the organization with the entity that was remembered into the associative memory at 304. At operation 308, the entity analytics engine 24 compares the similar, retrieved TERs obtained from the associative memory 22 with the specific TER input by the user. At operation 310 a determination is made if justification of any facet of the TER is required, and if so, further updating of the TER is performed to add in details that justify any expense item. If no justification is required, then at operation 312 the computer system 18 may optionally generate a report for the user that shows the user her/his TER as well as other related TERs for similar trips.

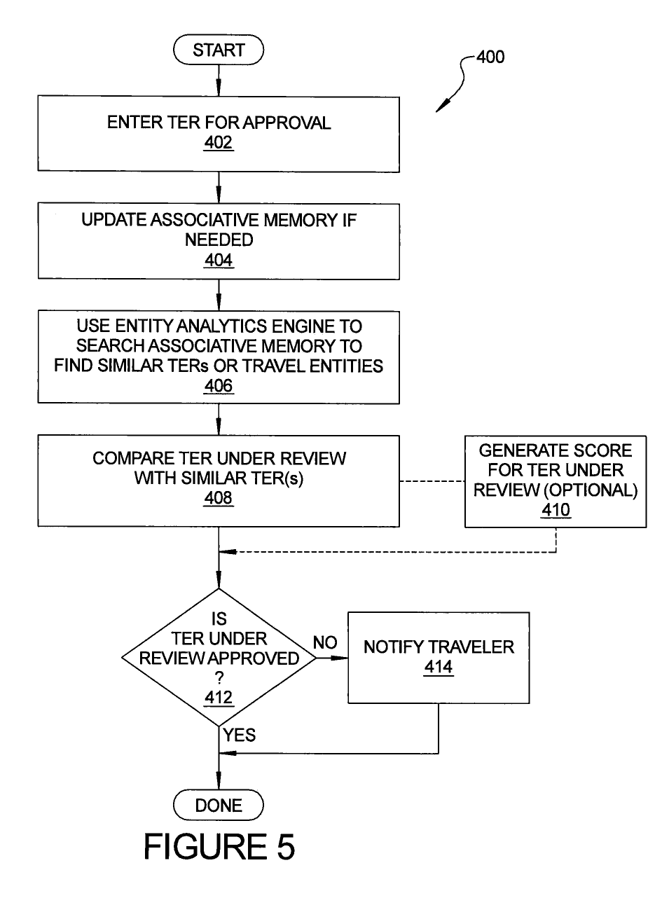

Referring to FIG. 5, a flowchart 400 is shown that represents operations that may be performed by management of an organization in inputting and grading a specific TER representing a trip taken by an individual of the organization. The grading may be done to assign a quantitative score to the previously submitted TER that represents a “cost effectiveness” of the trip taken by the individual.

At operation 402 a (manager) user enters a TER number (one created by process 300 by the traveler) of the completed trip using the input device 30. At operation 404 the entity analytics engine 24 is used to update the associative memory 22 with new information, if this has not already been done by the individual. This may include the attributes associated with the manager doing the review. At operation 406 the user (e.g., manager) uses the entity analytics engine 22 to search the associative memory 22 for similar TER entities. The entity analytics engine 22 uses all the information in the TER to find other TERs that are similar. This may include TER's with on or more of the following similarities: to the same location for the same purpose, for the same trip duration, or by the same type of employee or same hotel.

At operation 408 the specific TER under review is compared with the retrieved, similar TERs. During this operation the comparison may involve comparing airline costs, hotel stay costs, car rental costs, or any other items that may be useful in determining an overall cost effectiveness of the TER being reviewed. The classification level of the individual who created the TER (i.e., entry level person, executive level person, etc.) may also be considered, as well as any other pertinent factors such as the time of year that travel took place to the destination (assuming that such would influence expected expenses). The organization may employ virtually any criteria that is helpful in making a judgment determination if the specific TER is reasonable in cost. The comparison may be performed by the computer system 28 or any other suitable processing component. At operation 410, the optional operation of generating a numerical score for the TER under consideration may be performed. The numerical score may optionally also be saved with the TER as part of the entity that represents the TER.

At operation 412 a determination is made if the specific TER under review is approved. If so, the process may be considered to be complete. If not, then at operation 414 the traveler may be notified that her/his TER was disapproved, or alternatively that she/he is invited to submit additional information that may explain specific charges.

The system 10 and method of the present disclosure is expected to find utility with organizations of all sizes, but is expected to be especially useful to large organizations that have hundreds or thousands of employees that travel on a regular basis, and that generate a correspondingly large volume of travel related expense information. A particular advantage of the system is the ability to readily identify entities (i.e., records of transactions with specific airlines, hotels, hotels, etc.) for the purpose of identifying those vendors or businesses that significant, repeated transactions are occurring with. This enables the system 10 to help an organization identify those vendors or businesses where a formalized agreement may be advantageous to establish for the purpose of providing discounts to the organization.

Another particular advantage of the system 10 is the use of the associative memory 22, and its ability to “learn” over time. Essentially the associative memory 22 and the entity analytics engine 24 both become more adept at identifying and categorizing similar or related travel related information with repeated use over a period of time. The system 10 of the present disclosure is especially helpful because it allows free text input, so the system examines every search term used in the input when performing its searching. The system 10 makes it possible to search thousands or more stored entities relating to previously submitted TERs and specific items that may be mentioned in previously submitted TERs to help a user create a new, optimized travel plan that allows users to “learn” better ways to travel. Importantly, the travel plan may be optimized both from a quantitative (cost) standpoint as well as a qualitative (quality) standpoint. The system 10 is also readily scalable to meet the needs of variously sized organizations but the larger the organization the faster it can learn “better” ways to travel.

Still another important advantage that the system 10 provides is that the various entities saved in the associative memory 22 may be searched to obtain various forms of useful statistical information. For example, the entities saved in the associative memory 22 may be grouped or “clustered” by management to determine “average” travel expenses for entities from which the group or cluster is being formed. Such entites may be associated with particular classification levels (i.e., entry level versus executive), or “average” travel expenses for individuals belonging to a certain department or division of an organization, or even “average” travel expenses for trips taken to specific destinations.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A method for assisting with evaluating travel related information, comprising:
defining a plurality of entity types for categorizing different types of travel related information;
using a data mining tool to search at least one database for stored travel related information, and to denote specific items of the travel related information as entities;
using the data mining tool to populate an associative learning memory with the entities and storing the entities in the associative learning memory;
using an entity analytics engine to assist a user in searching the associative learning memory for specific ones of the entities that are at least one of identical or similar to specific travel related information provided by the user; and
displaying retrieved ones of the entities for evaluation by the user.

2. The method of claim 1, wherein at least one of the entity types comprises one of a travel expense report (TER) and a travel plan (TP).

3. The method of claim 1, wherein at least one of the entity types comprises a TER evaluation report.

4. The method of claim 2, further comprising using an input device to receive a free text input query from an individual to at least one of obtain entity information from, and to input the travel related information to, the associative learning memory.

5. The method of claim 4, wherein said using an input device to receive a free text input query comprises using an input device to enable the user to input a TER entity number or a travel plan number.

6. The method of claim 5, further comprising using the entity analytics query software module to receive TER entity number or travel plan number from the input device and to control the entity analytics engine in searching for relevant entities.

7. The method of claim 1, further comprising using an historical database to store travel related information generated before a predetermined date.

8. The method of claim 1, further comprising using a display system of a computer system to display the entities obtained pursuant to a search query.

9. The method of claim 1, further comprising using the entity analytics engine to update the associative memory with at least one of:
new entities associated with new travel related information provided by an individual during the planning of a trip;
new entities associated with new travel related information provided by an individual subsequent to completing a trip; and
a new entity associated with a new TER evaluation report generated by an individual after reviewing a specific TER.

10. A method for managing and analyzing travel information, comprising:
using an associative learning memory to store a plurality of entities, each one of the entities relating to a specific piece of travel related information;
using an input device that allows a user to input a travel plan or travel expense report (TER) relating to specific travel related information;
using an entity analytics engine responsive to the input device to search the associative learning memory for specific ones of the entities that are related to the travel plan or the TER input by the user; and
displaying the entities retrieved by the entity analytics engine on a display for consideration by the user.

11. The method of claim 10, wherein:
the travel plan (TP) pertains to a specific trip taken by a specific individual;
the travel expense report (TER) pertains to a specific trip taken by a specific individual; and
a TER evaluation report is generated after evaluation of a given TER.

12. The method of claim 10, further comprising using an entity analytics query software module to interface the input device to the entity analytics engine to assist in analyzing the travel plan or TER and performing searching of the associative learning memory for relevant entities relating to the travel plan or TER.

13. The method of claim 10, further comprising updating the associative learning memory with new entities relating to new travel related information input by the user.

14. The method of claim 13, further comprising using the input device to receive a travel expense report (TER) evaluation report from an individual and using the entity analytics engine to update the associative memory with a new entity relating to the TER evaluation report.

15. The method of claim 10, wherein said inputting a travel plan or TER by the user comprises inputting a query that includes at identifies a TER or travel plan by a number.

16. The method of claim 10, further comprising using a data mining tool to initially populate the associative learning memory with a plurality of entities using travel related information obtained from a database.

17. The method of claim 16, further comprising using the entity analytics engine to compile a plurality of entities that relate to an upcoming planned trip by the user, and to generate an optimized itinerary for the user.

18. A system for assisting with evaluating travel related information, comprising:
a data mining tool to search at least one database for stored travel related information, and to denote specific items of the travel related information as entities;
an associative learning memory in communication with the data mining tool and adapted to store the entities created by the data mining tool; and
an entity analytics engine responsive to travel entities provided by a user, where the entities each have a plurality of entity attributes;
the entity analytics engine further being adapted to search the associative learning memory for specific ones of the entities that are at least one of identical or similar to at least one of the entity attributes, and to collect the identical or similar entities stored in the associative learning memory to generate a report that assists the user in one of planning a trip or evaluating a completed trip.

19. The system of claim 18, further comprising an input device that enables a user to input a travel plan number or a TER number to the entity analytics engine, wherein the travel plan number OR TER number uniquely identifies a specific travel plan or TER in the associative memory.

20. The system of claim 18, further comprising using the entity analytics engine to receive new travel related information pertaining to a completed trip and to update the associative memory with new entities relating to said completed trip.

21. The system of claim 18, wherein the entity analytics engine is adapted to store at least one of travel expense reports (TERs) and travel expense report evaluations as a new entity in the associative memory for future retrieval.
